(19) United States
(12) Patent Application Publication
(10) Pub. No.: US 2024/0399836 A1
(43) Pub. Date: Dec. 5, 2024

(54) HEAT-TREATMENT MODULE WITH EXPANSION MEMBER

(71) Applicant: VALEO SYSTEMES THERMIQUES, Le Mesnil-Saint-Denis (FR)

(72) Inventors: Julien Tissot, Le Mesnil-Saint-Denis Cedex (FR); Kamel Azzouz, Le Mesnil-Saint-Denis Cedex (FR); Moussa Nacer Bey, Le Mesnil-Saint-Denis Cedex (FR); Julio Guerra, Le Mesnil-Saint-Denis Cedex (FR)

(73) Assignee: VALEO SYSTEMES THERMIQUES, Le Mesnil-Saint-Denis (FR)

(21) Appl. No.: 18/689,071

(22) PCT Filed: Sep. 5, 2022
(86) PCT No.: PCT/EP2022/074655

§ 371 Date: Mar. 5, 2024

(30) Foreign Application Priority Data
Sep. 6, 2021 (FR) FR2109328

(51) Int. Cl. B60H 1/32; F28D 21/00

(52) U.S. Cl. CPC B60H 1/3227; B60H 2001/3297; F28D 2021/0084; F28D 2021/0085

(57) ABSTRACT

A heat treatment module for a heat treatment system of a vehicle is disclosed. The heat treatment module includes a first heat exchanger, a second heater, and an internal heat exchanger. The first heat exchanger and the second heat exchanger both are configured to create an exchange of heat between a refrigerant and a heat transfer liquid. The internal heat exchanger is configured to create an exchange of heat within the refrigerant, which in heat treatment system is subjected to two different temperature levels. The heat treatment module includes an expansion member that is at least secured to the first heat exchanger and/or the second heat exchanger.

The present invention relates to the field of heat treatment systems within vehicles, and more particularly it concerns a heat treatment module within such a heat treatment system.

Motor vehicles are currently equipped with a refrigerant circuit and with at least one heat transfer liquid circuit, which are both used to contribute to a heat treatment of various zones or various components of the vehicle. It is notably known for the refrigerant circuit and/or the heat transfer liquid circuit to be used to thermally treat an air flow sent into the passenger compartment of the vehicle equipped with such a circuit.

In another application of this circuit, it is known for the heat transfer liquid circuit to be used to cool components of the powertrain of the vehicle, such as an electrical storage device, the latter being used to supply energy to an electric motor capable of moving the vehicle. The heat treatment system thus supplies the energy capable of cooling the electrical storage device when it is used.

The refrigerant and the heat transfer liquid circulate within their respective circuits and interact with each other by means of a plurality of heat exchangers, each providing an exchange of heat between the two aforementioned fluids. In order to improve the compactness of the heat treatment system, a plurality of these heat exchangers may be grouped in a heat-treatment module. Given that motor vehicle manufacturers have the aim of continually improving their vehicles, one object of the improvement of such heat treatment modules is that of grouping more elements of the heat treatment system within the heat treatment modules.

The present invention falls within this context by proposing a heat treatment module for a heat treatment system of a vehicle, comprising a first heat exchanger, a second heat exchanger and an internal heat exchanger, the first heat exchanger and the second heat exchanger both being configured to create an exchange of heat between a refrigerant and a heat transfer liquid, the internal heat exchanger being configured to create an exchange of heat within the refrigerant, which in the heat treatment system is subjected to two different temperature levels, characterized in that the heat treatment module comprises an expansion member that is at least secured to the first heat exchanger and/or the second heat exchanger.

Thus such a heat treatment module according to the invention enables an expansion member and three exchangers to be grouped together, providing an exchange of heat not only between the refrigerant and the heat transfer liquid but also within a refrigerant circuit, which is the case for the internal heat exchanger. Thus such a configuration enables the expansion member to be integrated with the heat treatment module, thereby avoiding the positioning of an expansion member remotely from the heat treatment module, as well as the provision of pipes for connecting this expansion member to the heat treatment module.

The first heat exchanger and the second heat exchanger provide heat exchange between the refrigerant and the heat transfer liquid, for the purpose of providing a number of functions that depend on the temperature of the refrigerant. By way of example, within these heat exchangers, the heat transfer liquid can condense the refrigerant in order to facilitate its subsequent expansion via the expansion member. According to other examples, the refrigerant may cool the heat transfer liquid so that the latter provides not only a function of heat treatment of the components of the vehicle's powertrain, but also the cooling of the air in the passenger compartment via the HVAC.

The internal heat exchanger forms part of the refrigerant circuit. In other words, the internal heat exchanger allows an exchange of heat between two temperature levels of the refrigerant, in order to provide thermal regulation of the refrigerant, thereby optimizing the thermal performance of the refrigerant circuit.

The expansion member is mechanically secured to at least two heat exchangers, in order to integrate it into the heat treatment module. According to one embodiment of the heat treatment module, the expansion member provides a fluid connection between the two heat exchangers, or between one of the heat exchangers and the internal heat exchanger.

According to a characteristic of the invention, the first heat exchanger comprises a first pass configured for the refrigerant to pass through it and a second pass configured for the heat transfer liquid to pass through it, the second heat exchanger comprising a first passage configured for the heat transfer liquid to pass through it, the internal heat exchanger comprising a first channel configured for the refrigerant to pass through it at a first temperature and a second channel configured for the refrigerant to pass through it at a second temperature, different from the first temperature.

The temperature of the refrigerant varies according to the pressure and the thermodynamic fluid state. Thus the terms “first temperature” and “second temperature” do not denote temperatures in the physical sense here, but rather a first temperature level and a second temperature level.

The heat exchange produced within the first heat exchanger therefore takes place between the refrigerant circulating in the first pass and the heat transfer liquid circulating in the second pass. The purpose of this heat exchange may be to condense the refrigerant in order to facilitate its subsequent expansion in the expansion member.

As in the case of the first heat exchanger, the heat exchange provided in the second heat exchanger takes place between the refrigerant circulating in the first passage and the heat transfer liquid circulating in the second passage. This heat exchange may be produced between the heat transfer liquid and the expanded refrigerant in order to cool the heat transfer liquid so that the latter may subsequently cool the components of the vehicle's powertrain.

The internal heat exchanger is configured to produce a heat exchange between the refrigerant circulating in the first channel and the refrigerant circulating in the second channel. As described above, this heat exchange produced within the internal heat exchanger enables the thermal regulation of the refrigerant to be optimized. It is the temperature difference between the first temperature and the second temperature that enables this heat exchange to take place correctly.

According to a characteristic of the invention, at least the first pass of the first heat exchanger and at least the first channel of the internal heat exchanger form a first section configured to cause the refrigerant to circulate at the first temperature. The first section extends between the refrigerant inlet of the heat treatment module and the expansion member. Thus the first section is the section where the refrigerant circulates at the highest temperature, which is the first temperature.

The first heat exchanger can thus enable the refrigerant to be condensed to facilitate its expansion, and if necessary can heat the heat transfer liquid so that the liquid provides a heating function in the passenger compartment if the associated heat treatment system has a configuration of the indirect heat pump type.

The internal heat exchanger also enables the refrigerant circulating at the first temperature to be cooled via a heat exchange performed with the refrigerant circulating at the second temperature.

According to a characteristic of the invention, at least the first passage of the second heat exchanger and at least the second channel of the internal heat exchanger form a second section configured to cause the refrigerant to circulate at the second temperature. The second section is thus arranged between the expansion member and an outlet of the heat treatment module, and provides for the circulation of the refrigerant at low temperature, corresponding to the second temperature. Thus the circulation in the first passage may be used to cool the heat transfer liquid circulating in the second passage. The cooled heat transfer liquid then circulates out of the heat treatment module in order to cool the components of the vehicle's powertrain. The refrigerant circulating in the second section also circulates within the second channel of the internal heat exchanger, so as to contribute to the heat exchange taking place in the internal heat exchanger as mentioned above.

According to a characteristic of the invention, the expansion member separates the first section from the second section within the heat treatment module. The expansion member provides an expansion of the refrigerant corresponding to a reduction of the pressure. This pressure reduction is accompanied by a temperature reduction. It is therefore the expansion member that enables the temperature of the refrigerant to be changed from the first temperature to the second temperature, thus separating the first section from the second section.

According to a characteristic of the invention, the first heat exchanger and the second heat exchanger each comprise a heat exchange unit at the end of which is positioned an upper wall for the first heat exchanger and an upper face for the second heat exchanger, the expansion member being positioned at the upper wall of the first heat exchanger and/or the upper face of the second heat exchanger, the upper wall of the first heat exchanger and the upper face of the second heat exchanger being arranged opposite the internal heat exchanger with respect to the heat exchange unit of at least one of the heat exchangers. This is a first embodiment of the heat treatment module according to the invention. The heat exchange unit is a structural area of each of the heat exchangers within which the appropriate heat exchange for the heat exchanger takes place. The expansion member, for its part, is arranged so as to be mechanically attached both to the upper wall of the first heat exchanger and to the upper face of the second heat exchanger. The two heat exchangers may, for example, be in contact with the internal heat exchanger, the upper wall of the first heat exchanger and the upper face of the second heat exchanger corresponding to the opposite part with respect to the heat exchange unit.

According to a characteristic of the invention, the first heat exchanger comprises an additional pass, the expansion member providing a direct fluid connection between the additional pass of the first heat exchanger and the first passage of the second heat exchanger. The additional pass enables the first channel of the internal heat exchanger to be fluidly connected to the expansion member, by travel through the first heat exchanger via the additional pass. By contrast with the first pass, no heat exchange takes place with the refrigerant circulating in the additional pass. Thus the additional pass allows a connection to be made between the first channel of the internal heat exchanger and the first passage of the second heat exchanger, by travel through the expansion member.

According to a characteristic of the invention, the first heat exchanger and the second heat exchanger form an assembly, the expansion member being positioned within a space interposed between the assembly formed by the heat exchangers and the internal heat exchanger. This is a second embodiment of the heat treatment module according to the invention. The space formed between the assembly of the two heat exchangers and the internal heat exchanger allow the expansion member to be housed, together with elements providing, for example, a fluid connection between the assembly of heat exchangers and the internal heat exchanger.

According to a characteristic of the invention, the space houses a connection unit providing a fluid connection between the first pass of the first heat exchanger and the first channel of the internal heat exchanger. After contributing to the heat exchange within the first heat exchanger, the refrigerant has to return to the first channel of the internal heat exchanger. It is the connection unit that enables the refrigerant to pass through the space between the heat exchanger assembly and the internal heat exchanger. For this purpose, the connection unit may comprise a pipe extending within its internal structure to provide for the circulation of the refrigerant.

According to a characteristic of the invention, the space houses at least one connection element contributing to a fluid connection between the first passage of the second heat exchanger and the second channel of the internal heat exchanger. The connection element may provide a fluid connection between an element external to the heat treatment module and the internal heat exchanger. Advantageously, the space houses two connection elements, providing, respectively, an inlet into the internal heat exchanger, and then an outlet from the internal heat exchanger, the latter marking the end of the second section of the heat treatment module.

The fluid connection between the second heat exchanger and the connection element may, for example, be a circulation of the refrigerant outside the heat treatment module. The refrigerant may also pass through a refrigerant accumulation device capable of retaining a liquid fraction of the refrigerant before recirculation into the internal heat exchanger via the connection element.

According to a characteristic of the invention, the expansion member provides a direct fluid connection between the first channel of the internal heat exchanger and the first passage of the second heat exchanger. Since the expansion member is housed in the space according to the second embodiment of the heat treatment module, the fluid connection between the internal heat exchanger and the second heat exchanger, and therefore the link between the first section and the second section, may easily be implemented.

According to a characteristic of the invention, at least one heat exchanger is a plate exchanger comprising a first terminal plate and a second terminal plate between which a stack of plates is positioned, the expansion member being secured to at least one of the terminal plates. A plate exchanger is made up of a stack of plates, said plates being stacked along a stacking axis. When the refrigerant and the heat transfer liquid circulate within the heat exchange units of one or other of the heat exchangers, if the latter are plate exchangers, the refrigerant and the heat transfer liquid circulate within gaps between the plates, said gaps corresponding to the passes for the first heat exchanger and to the passages for the second heat exchanger. Advantageously, the arrangement of the plates creates an alternating circulation between the first pass and the second pass for the first heat exchanger, and between the first passage and the second passage for the second heat exchanger. Such an alternating circulation ensures that the heat exchange takes place correctly within each of the heat exchangers.

“Terminal plates” is taken to mean the two plates located at the ends of the heat exchange unit. In other words, it means the two plates that are not enclosed on either side by two adjacent plates. Thus, if one of the heat exchangers is a plate exchanger, the expansion member is secured to one of the terminal plates of this heat exchanger, or of these heat exchangers.

According to a characteristic of the invention, the expansion member may be secured to the first terminal plate of each of the heat exchangers. The first terminal plate of the heat exchangers corresponds to the upper wall of the first heat exchanger and to the upper wall of the second heat exchanger. In other words, it is at the first terminal plate of each of the heat exchangers that the expansion member is secured, according to the first embodiment as described above.

According to a characteristic of the invention, the expansion member may be secured to the second terminal plate of each of the heat exchangers. The second terminal plate corresponds to the plate of each of the heat exchangers arranged facing the internal heat exchanger. Therefore, it is in the context of the second embodiment of the heat treatment module that the expansion member is secured to the second terminal plate of each of the heat exchangers.

According to a characteristic of the invention, the internal heat exchanger is a plate exchanger comprising at least one end plate, the expansion member being secured to the end plate. Like the heat exchangers, the internal heat exchanger may also be a plate exchanger. The refrigerant of the first section and the refrigerant of the second section thus also circulate between the plates of the internal heat exchanger, so that the heat exchange between the two second sections can take place. In this configuration, the end plate corresponds to one of the two plates not enclosed on either side by two adjacent plates. More precisely, the end plate of the internal heat exchanger corresponds to the plate arranged facing the heat exchangers. According to the second embodiment of the heat treatment module, the expansion member is arranged in the space within the assembly comprising the two heat exchangers and the internal heat exchanger. The expansion member is therefore secured to the two heat exchangers and to the internal heat exchanger.

According to a characteristic of the invention, the expansion member is welded to the first heat exchanger and to the second heat exchanger. This characteristic may apply to all the embodiments of the heat treatment module according to the invention. The welding may, for example, consist in the brazing of the expansion member to the heat exchangers. The expansion member may also be secured to the heat exchangers in another way, by screwing for example.

According to a characteristic of the invention, the expansion member is welded to the internal heat exchanger. This characteristic is applicable only to the second embodiment among the embodiments described above. Since the expansion member is interposed between the set of heat exchangers and the internal heat exchanger, the mechanical fastening of the heat treatment module may be strengthened by additionally welding the expansion member to the internal heat exchanger.

According to a characteristic of the invention, the internal heat exchanger is inscribed in a projection on a plane perpendicular to a stacking axis of the plates, a projection on the plane perpendicular to the stacking axis of the plates of an assembly formed by the first heat exchanger and the second heat exchanger being contained within the projection of the internal heat exchanger. By incorporating the planes of projection of the heat exchangers within the plane of projection of the internal heat exchanger, at least two dimensions of the heat treatment module can be kept equal to the dimensions of the internal heat exchanger. Such a configuration reinforces the compactness of the heat treatment module.

According to a characteristic of the invention, the second heat exchanger comprises an additional passage fluidly connecting the second channel of the internal heat exchanger to the outlet of the heat treatment module. As in the case of the additional pass, no heat exchange takes place with the refrigerant circulating in the additional passage.

According to a characteristic of the invention, the first heat exchanger comprises a supplementary pass fluidly connecting the second channel of the internal heat exchanger to the outlet of the heat treatment module. As in the case of the additional pass, no heat exchange takes place with the refrigerant circulating in the supplementary pass.

Other features and advantages of the invention will become more clearly apparent from the following description and from a number of exemplary embodiments provided by way of non-limiting indication with reference to the accompanying schematic drawings, in which:

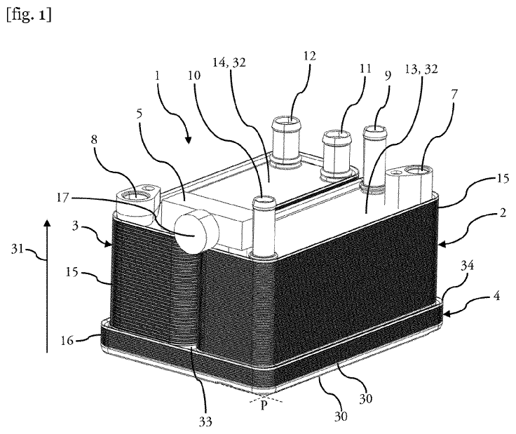

FIG. 1 shows a first embodiment of a heat treatment module according to the invention,

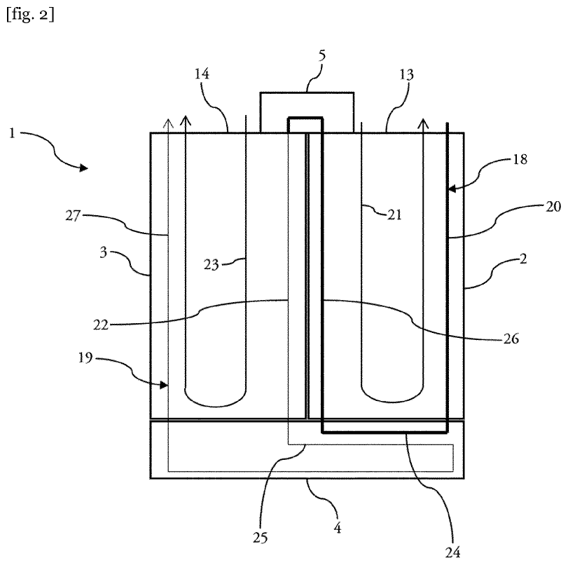

FIG. 2 shows a first example of a circulation of a refrigerant and a heat transfer liquid within the first embodiment of the heat treatment module,

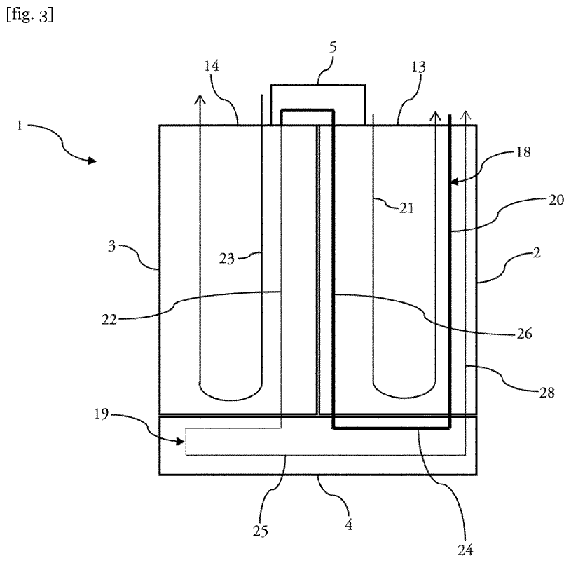

FIG. 3 shows a second example of a circulation of the refrigerant and the heat transfer liquid within the first embodiment of the heat treatment module,

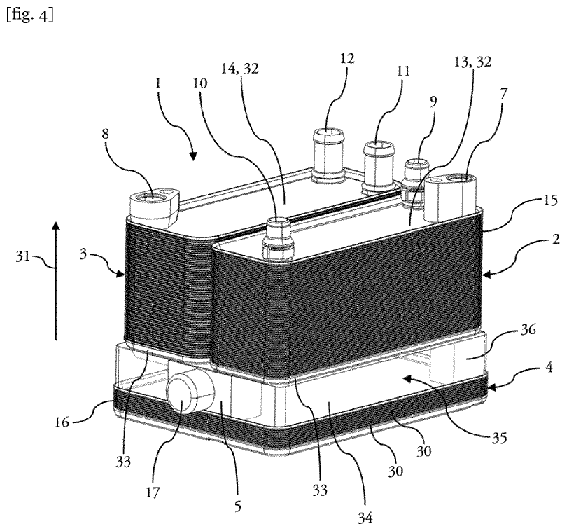

FIG. 4 shows a second embodiment of the heat treatment module according to the invention,

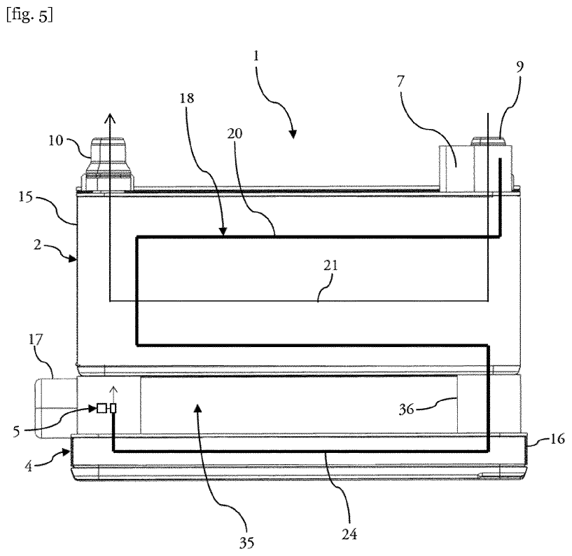

FIG. 5 shows a first part of the circulation of the refrigerant within the second embodiment of the heat treatment module,

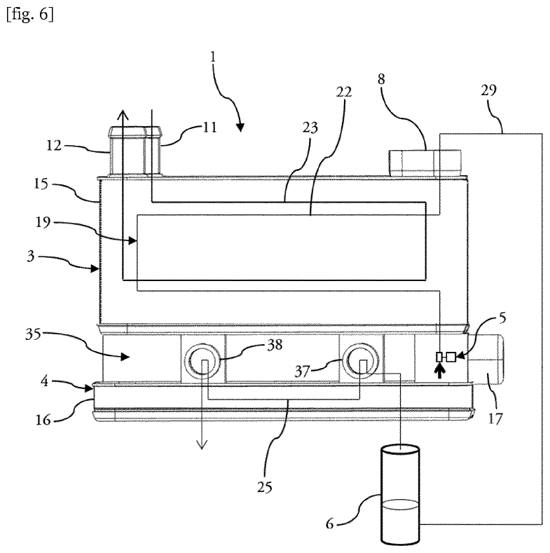

FIG. 6 shows a second part of the circulation of the refrigerant within the second embodiment of the heat treatment module.

FIG. 1 shows a first embodiment of a heat treatment module 1 according to the invention. The heat treatment module 1 forms part of a heat treatment system for a vehicle, it being possible for said system to simultaneously provide a heat treatment of a vehicle interior and a heat treatment of various components of a powertrain of the vehicle. To this end, the heat treatment system comprises at least one refrigerant circuit and at least one heat transfer liquid circuit, and the heat treatment module 1 comprises portions of these two circuits. The heat treatment module 1 is thus able to provide the circulation of a refrigerant and a heat transfer liquid within it. By way of example, the refrigerant may be a fluid of the R134a or R1234yf type, and the heat transfer liquid may be glycol water.

The heat treatment module 1 groups together a first heat exchanger 2, a second heat exchanger 3 and an internal heat exchanger 4, each performing a specific function enabling the correct operation of the heat treatment system for the vehicle. As a result, the first heat exchanger 2 and the second heat exchanger 3 are configured to provide an exchange of heat between the refrigerant and the heat transfer liquid, the exchange of heat within each of the heat exchangers 2, 3 being specific to one or more functions of the heat treatment system. The internal heat exchanger 4 provides an exchange of heat intrinsic to the refrigerant circuit, but between two temperature levels of said refrigerant, specifically at a first temperature and a second temperature. The details relating to the circulation of the refrigerant and the heat transfer liquid and to all of the exchanges of heat taking place within the heat treatment module 1 will be described below.

In order to make the refrigerant enter and exit the heat treatment module 1, the latter comprises a refrigerant inlet 7 and a refrigerant outlet 8. In FIG. 1, the refrigerant inlet 7 is positioned at the first heat exchanger 2 and the refrigerant outlet 8 is positioned at the second heat exchanger 3, but these positions may vary depending on the circulation of the refrigerant within the heat treatment module 1.

Furthermore, the first heat exchanger 2 comprises a heat transfer liquid inlet 9 and a heat transfer liquid outlet 10, whereas the second heat exchanger 3 comprises an inlet orifice 11 and an outlet orifice 12. By contrast to the refrigerant, the heat transfer liquid entering one of the heat exchangers 2, 3 circulates only within said heat exchanger 2, 3. As a result, the heat transfer liquid entering respectively via the heat transfer liquid inlet 9 or the inlet orifice 11 necessarily exits again via the heat transfer liquid outlet 10 or the outlet orifice 12, respectively.

The particular feature of the heat treatment module 1 according to the invention is that it also comprises an expansion member 5 for expanding the refrigerant when the latter passes through the expansion member 5. As shown in FIG. 1, the expansion member 5 is mechanically secured to the first heat exchanger 2 and the second heat exchanger 3. Such securing of the expansion member 5 may be performed, for example, by welding or by screwing. The expansion member 5 comprises an electronic controller 17 for controlling a degree of expansion of the refrigerant within the expansion member 5.

Each heat exchanger 2, 3 comprises a heat exchange unit 15 within which the heat exchange takes place between the refrigerant and the heat transfer liquid. The first heat exchanger 2 comprises an upper wall 13, whereas the second heat exchanger 3 comprises an upper face 14. The upper wall 13 and the upper face 14 correspond to the wall and the face that are situated opposite the internal heat exchanger 4 with respect to the respective heat exchange unit 15 of each of the heat exchangers 2, 3. According to this first embodiment of the heat treatment module 1, the expansion member 5 is secured to the upper wall 13 of the first heat exchanger 2 and to the upper wall 14 of the second heat exchanger 3.

The first heat exchanger 2 and/or the second heat exchanger 3 and/or the internal heat exchanger 4 may be plate exchangers. In FIG. 1, the three exchangers 2, 3, 4 are plate exchangers. Each of these plate exchangers comprises a plurality of plates 30 stacked on one another along a stacking axis 31. The stacking axes 31 of the heat exchangers 2, 3 and of the internal heat exchanger 4 are parallel or substantially parallel to one another.

It is the stack of plates 30 that allows the circulation of the refrigerant and the heat transfer liquid for the heat exchangers 2, 3, the latter circulating between the plates 30. The circulation between the refrigerant and the heat transfer liquid for the heat exchangers 2, 3 and the circulation between the refrigerant at the first temperature and the refrigerant at the second temperature within the internal heat exchanger 4 preferably takes place alternately from one plate 30 to the next in order to optimize the exchange of heat.

The first heat exchanger 2 and the second heat exchanger 3 each comprise a first terminal plate 32 and a second terminal plate 33, each corresponding to the end plates of each of the heat exchangers 2, 3. In other words, these terminal plates 32, 33 close the heat exchange unit 15 at each of its ends. In FIG. 1, the first terminal plate 32 of the two heat exchangers 2, 3 corresponds to the plate 30 situated opposite the internal heat exchanger 4 with respect to the heat exchange unit 15, whereas the second terminal plate 33 of the two heat exchangers 2, 3 corresponds to the plate 30 facing toward the internal heat exchanger 4. According to the first embodiment of FIG. 1, the expansion member 5 is therefore secured to each of the first terminal plates 32 of each of the heat exchangers 2, 3. The internal heat exchanger 4 comprises a body 16, which is also formed by a stack of plates 30 and is closed by an end plate 34 which corresponds to the plate 30 facing towards the two heat exchangers 2, 3.

The internal heat exchanger 4 can be inscribed in a projection P perpendicular to the stacking axis 31 of the plates 30 of said internal heat exchanger 4. It should be noted that a projection of the first heat exchanger 2 and the second heat exchanger 3 are comprised in the projection P of the internal heat exchanger 4. Such an arrangement makes it possible to improve the compactness of the heat treatment module 1.

FIG. 2 and FIG. 3 show two examples of circulation of the refrigerant and the heat transfer liquid within the first embodiment of the heat treatment module 1, For these two figures, the circulation of the refrigerant and the heat transfer liquid is shown by lines of different thicknesses, the thickest lines corresponding to the circulation of the refrigerant within a first section 18, the thinnest lines corresponding to the circulation of the refrigerant within a second section 19 and the lines of intermediate thickness corresponding to the circulation of the heat transfer liquid.

As described above, the refrigerant circulates in the heat treatment module 1 at two different temperatures. As a result, the refrigerant circulating in the first section 18 corresponds to the refrigerant at the first temperature, whereas the refrigerant circulating in the second section 19 corresponds to the refrigerant at the second temperature. The expansion member 5 separates the first section 18 from the second section 19 since the expansion of the refrigerant causes it to switch from the first temperature to the second temperature, the first temperature being higher than the second temperature.

According to the first circulation example illustrated in FIG. 2, the refrigerant enters the heat treatment module 1, more particularly a first pass 20 of the first heat exchanger 2. The first section 18, where the refrigerant is at the first temperature, starts at this first pass 20. Simultaneously, the heat transfer liquid circulates within a second pass 21 of the first heat exchanger 2. The exchange of heat occurring in the first heat exchanger 2 therefore takes place between the refrigerant circulating in the first pass 20 and the heat transfer liquid circulating in the second pass 21. Within the first heat exchanger 2, the refrigerant is at a higher temperature than the heat transfer liquid is. The objective of this exchange of heat is notably to condense the refrigerant via the heat transfer liquid in order to facilitate its expansion via the expansion member 5. This exchange of heat can also serve to heat the heat transfer liquid within the scope of a configuration of the heat pump type, if this is the case for the associated heat treatment system.

After having circulated within the first pass 20, the refrigerant circulates within the internal heat exchanger 4 via a first channel 24 in order to exchange heat with the refrigerant circulating in the second section 19. The exchange of heat brought about within the internal heat exchanger 4 makes it possible to optimize the thermal performance of the refrigerant circuit.

After having passed through the first channel 24, the refrigerant returns to the first heat exchanger 2 and circulates within an additional pass 26. This additional pass 26 makes it possible to fluidly connect the first pass 24 to the expansion member 5. As a result, the refrigerant circulating in the additional pass 26 does not undergo any exchange of heat, in spite of the fact that it passes through the first heat exchanger 2.

The refrigerant thus goes to the expansion member 5 which, by expanding the refrigerant, effects the transition between the first section 18 and the second section 19.

The refrigerant exits the expansion member 5 at the second temperature and circulates within a first passage 22 arranged in the second heat exchanger 3. Simultaneously, the heat transfer liquid circulates within a second passage 23 of the second heat exchanger 3. The exchange of heat occurring in the second heat exchanger 3 therefore takes place between the refrigerant circulating in the first passage 22 and the heat transfer liquid circulating in the second passage 23. Within the second heat exchanger 3, the refrigerant is at a lower temperature than the heat transfer liquid. The objective of this exchange of heat is notably to cool the heat transfer liquid via the refrigerant. The heat transfer liquid cooled in this way can subsequently circulate to one or more elements of the powertrain of the vehicle and heat treat the latter, or to an exchanger located in the HVAC, to cool the air in the passenger compartment. This exchange of heat also makes it possible to at least partially evaporate the refrigerant in order to optimize the performance of the refrigerant circuit.

At the outlet of the first passage 22, the refrigerant returns to the internal heat exchanger 4, but this time via a second channel 25. The exchange of heat brought about within the internal heat exchanger 4 therefore takes place between the refrigerant circulating in the first channel 24 and the refrigerant circulating in the second channel 25.

Having circulated within the second channel 25, the refrigerant exits the heat treatment module 1 via the second heat exchanger 3, via an additional passage 27. As for the additional passage 26, the refrigerant circulating in the additional passage 27 does not undergo any heat exchange and the arrangement simply allows the refrigerant to exit the heat treatment module 1. After this, the refrigerant may, for example, circulate to a compression device which is not shown.

FIG. 3 shows a second example of circulation within the first embodiment of the heat treatment module 1. This second example of circulation differs from the first example of circulation solely in the exit of the refrigerant from the heat treatment module 1 via the second channel 25. Thus, instead of passing through the additional passage, as shown in FIG. 2, the refrigerant passes back through the first heat exchanger 2 via a supplementary pass 28 within which, as for the additional pass 26, no heat exchange takes place. According to this example, the refrigerant outlet shown in FIG. 1 on the second heat exchanger 3 must be positioned on the first heat exchanger 2 in this case.

FIG. 4 shows a second embodiment of the heat treatment module 1. This second embodiment is distinguished from the first embodiment by the position of the expansion member 5. Reference will therefore be made to the description of FIG. 1 with regard to everything concerning the characteristics common to the two embodiments.

The second embodiment is distinguished from the first embodiment in that it comprises a space 35 separating an assembly formed by the first heat exchanger 2 and the second heat exchanger 3 and the internal heat exchanger 4. The space 35 makes it possible to house a plurality of elements, notably the expansion member 5 which is therefore interposed between the two heat exchangers 2, 3 and the internal heat exchanger 4 in this case. As a result, according to this second embodiment, the expansion member 5 is secured to the first heat exchanger 2, the second heat exchanger 3 and the internal heat exchanger 4, for example by welding.

It can also be seen that the space 35 also houses a connection unit 36. The latter provides a fluid connection between the first heat exchanger 2 and the internal heat exchanger 4 and thus allows the refrigerant to pass through the space 35.

According to the second embodiment, the expansion member 5 is secured to the second terminal plate 33 of the first heat exchanger 2 and the second heat exchanger 3. As mentioned above, the second terminal plate 33 corresponds to the plate 30 of the first heat exchanger 2 and the second heat exchanger 3 which faces toward the internal heat exchanger 4. Since the expansion member 5 is in contact with the internal heat exchanger 4 in this embodiment, said expansion member 5 is therefore secured to the end plate 34 of said internal heat exchanger 4.

FIG. 5 schematically illustrates the circulation of the refrigerant within the first section 18 and the circulation of the heat transfer liquid within the first heat exchanger 2. As in FIGS. 2 and 3, the circulations in FIGS. 5 and 6 are shown by lines of different thicknesses, the thickest lines corresponding to the circulation of the refrigerant within the first section 18, the thinnest lines corresponding to the circulation of the refrigerant within the second section 19 and the lines of intermediate thickness corresponding to the circulation of the heat transfer liquid.

The refrigerant enters the first pass 20 of the first heat exchanger 2 via the refrigerant inlet 7, whereas the heat transfer liquid enters the second pass 21 via the heat transfer liquid inlet 9. As is the case for the first embodiment, the exchange of heat brought about in the first heat exchanger 2 takes place between the refrigerant circulating in the first pass 20 and the heat transfer liquid circulating in the second pass 21. After this exchange of heat, the heat transfer liquid exits the first heat exchanger 2 via the heat transfer liquid outlet 10.

The refrigerant, for its part, goes to the first channel 24 of the internal heat exchanger 4 via the connection unit 36 mentioned above. After having contributed to the exchange of heat brought about within the internal heat exchanger 4, the refrigerant can then go directly to the expansion member 5. It will thus be understood that the second embodiment of the heat treatment module 1, and particularly the arrangement of the expansion member 5, makes it possible to avoid installing the additional pass as in the case of the first embodiment. The expansion member 5 thus allows a direct fluid connection between the first channel 24 of the internal heat exchanger 4 and the first passage of the second heat exchanger.

FIG. 6 illustrates the rest of the circulation of the refrigerant, that is to say the second section 19 of the refrigerant circuit, after the refrigerant has been expanded by the expansion member 5. FIG. 6 also provides an illustration of the fact that the space 35, in addition to accommodating the expansion member 5 and the connection unit, also houses a first connection element 37 and a second connection element 38 allowing the refrigerant to access the second channel 25 and to exit it from the outside of the heat treatment module 1. The first connection element 37 contributes to the fluid connection between the first passage 22 and the second channel 25, as described below.

After having been expanded by the expansion member 5, the refrigerant circulates within the first passage 22 of the second heat exchanger 3. Since the refrigerant is at the second temperature by circulating in the second section 19, it is possible to cool the heat transfer liquid circulating in the second passage 23 after its entry via the inlet orifice 11 and before its exit via the outlet orifice 12.

After the refrigerant has been at least partially evaporated during the heat exchange brought about in the second heat exchanger 3, it exits the latter via the refrigerant outlet 8, and may, for example, circulate within an external pipe 29 until it reaches an accumulation device 6 external to the heat treatment module 1. The accumulation device 6 contains a liquid fraction of refrigerant that has not been evaporated during the exchange of heat brought about in the second heat exchanger 3. Thus the accumulation device 6 avoids the circulation of refrigerant in the liquid state to the compression device, which is only able to compress a small percentage of oil and refrigerant in the liquid state, mixed with the refrigerant in the gaseous state.

Thus only a small percentage of oil and refrigerant in the liquid state, mixed with the refrigerant in the gaseous state, exits the accumulation device and circulates to the first connection element 37 in order to circulate in the second channel 25. The first connection element 37 therefore indirectly provides the connection between the first passage 22 and the second channel 25. The exchange of heat brought about in the internal heat exchanger 4 is performed with the refrigerant circulating in the first channel, as illustrated in FIG. 5. The refrigerant circulating in the second channel 25 then exits via the second connection element 38 in order to reach the compression device, which is not illustrated.

Of course, the invention is not limited to the examples that have just been described, and numerous modifications may be made to these examples without departing from the scope of the invention.

The invention, as has just been described, does indeed achieve its stated objective, and makes it possible to propose a heat treatment module grouping together two heat exchangers, an expansion member secured to these two heat exchangers, and an internal heat exchanger. Variants that are not described here may be implemented without departing from the context of the invention, provided that, in accordance with the invention, they comprise a heat treatment module according to the invention.

1. A heat treatment module for a heat treatment system of a vehicle, the heat treatment module comprising:
a first heat exchanger,
a second heat exchanger, and
an internal heat exchanger,
wherein the first heat exchanger and the second heat exchanger both are configured to create an exchange of heat between a refrigerant and a heat transfer liquid,
wherein the internal heat exchanger is configured to create an exchange of heat within the refrigerant, which in the heat treatment system is subjected to two different temperature levels,
wherein the heat treatment module comprises an expansion member that is at least secured to the first heat exchanger and/or the second heat exchanger.

2. The heat treatment module as claimed in claim 1,
wherein the first heat exchanger comprises a first pass configured for the refrigerant to pass through it and a second pass configured for the heat transfer liquid to pass through it,
the second heat exchanger comprising a first passage configured for the refrigerant to pass through it and a second passage configured for the heat transfer liquid to pass through it,
the internal heat exchanger comprising a first channel configured for the refrigerant to pass through it at a first temperature and a second channel configured for the refrigerant to pass through it at a second temperature different than the first temperature.

3. The heat treatment module as claimed in claim 2,
wherein at least the first pass of the first heat exchanger and at least the first channel of the internal heat exchanger form a first section configured to cause the refrigerant to circulate at the first temperature.

4. The heat treatment module as claimed in claim 3,
wherein at least the first passage of the second heat exchanger and at least the second channel of the internal heat exchanger form a second section configured to cause the refrigerant to circulate at the second temperature.

5. The heat treatment module as claimed in claim 4,
wherein the expansion member separates the first section from the second section within the heat treatment module.

6. The heat treatment module as claimed in claim 2,
wherein the first heat exchanger and the second heat exchanger each comprise a heat exchange unit at the end of which is positioned an upper wall for the first heat exchanger and an upper face for the second heat exchanger,
wherein the expansion member is positioned at the upper wall of the first heat exchanger and/or the upper face of the second heat exchanger,
wherein the upper wall of the first heat exchanger and the upper face of the second heat exchanger are arranged opposite the internal heat exchanger with respect to the heat exchange unit of at least one of the heat exchangers.

7. The heat treatment module as claimed in claim 6,
wherein the first heat exchanger comprises an additional pass,
wherein the expansion member provides a direct fluid connection between the additional pass of the first heat exchanger and the first passage of the second heat exchanger.

8. The heat treatment module as claimed in claim 2,
wherein the first heat exchanger and the second heat exchanger form an assembly,
wherein the expansion member is positioned within a space interposed between the assembly formed by the heat exchangers and the internal heat exchanger.

9. The heat treatment module as claimed in claim 8,
wherein the space houses a connection unit providing a fluid connection between the first pass of the first heat exchanger and the first channel of the internal heat exchanger.

10. The heat treatment module as claimed in the claim 8,
wherein the space houses at least one connection element contributing to a fluid connection between the first passage of the second heat exchanger and the second channel of the internal heat exchanger.

11. The heat treatment module as claimed in claim 8,
wherein the expansion member provides a direct fluid connection between the first channel of the internal heat exchanger and the first passage of the second heat exchanger.
